(19) United States
(12) Patent Application Publication
(10) Pub. No.: US 2009/0246476 A1
(43) Pub. Date: Oct. 1, 2009

(54) DECORATED LAYER STRUCTURE AND THE PRODUCTION THEREOF

(75) Inventors: Francoise Mennechez, Orleans (FR); Jean-Pierre Odile, Villeneuve Sur Bellot (FR); Virginie Bousquet, Nogentel (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 11/720,968

(22) PCT Filed: Dec. 6, 2005
(86) PCT No.: PCT/FR2005/051044

§ 371 Date: Nov. 19, 2007

(30) Foreign Application Priority Data
Dec. 6, 2004 (FR) 0452875

(51) Int. Cl. C03C 17/34; B32B 3/10; H05B 3/20

(52) U.S. Cl. 428/187; 428/203; 427/108

(57) ABSTRACT

The invention relates to a decorated structure (100) comprising
an at least partially transparent substrate (1)
an enamel-based decorative element (2) on one face of the substrate,
a functional layer (3) that is chosen from an electrically supplied heating layer or a low-emissive layer, the layer being deposited on said face and at least partially covering said decorative element,
   and also the method for manufacturing this structure.

The present invention relates to the field of decorated structures and more particularly relates to a layered decorated structure and its method of manufacture.

In most of the known applications using decorated glass, the decoration is designed to be seen through the thickness of the glass. Therefore a glass decorated with an enamel, for example white enamel like a radiator façade, is used. This decorated glass is assembled with an additional heating body preferably in the form of a glass coated with an electrically conductive layer having an appropriate electric resistance, such as a fluorine-doped tin oxide layer.

The first object of the invention is to provide a structure that is both decorated and has a functional layer, a heating layer or a layer having a low-emissive property, the structure according to the invention being capable of ensuring optimal aesthetics and performance.

Accordingly, the invention proposes a structure comprising:
an at least partially transparent substrate,
an enamel-based decorative element on one face of the substrate,
a functional layer that is chosen from an electrically supplied heating layer or a low-emissive layer, the layer being deposited on said face and at least partially covering said decorative element.

The applicant has found that, if this type of functional layer is placed between the substrate and the decoration, the decoration is distorted and/or any defects of the layer are revealed unless the layer is substantially modified (for example by drastically reducing its thickness) which would then lose its functionality.

By placing the functional layer on top, the decorative element retains its appearance intact and is not distorted in transmission and/or in reflection by the presence of the layer. The aesthetics are therefore retained.

Against all expectations the layer thus deposited on the decoration—which thereby creates a certain roughness—retains its functionality even when this layer has a thickness that is markedly less than the thickness of the decoration.

For the heating layer, electrical continuity is preserved. In addition, when the layer is chosen to be low-emissive, its functionality remains intact even in the location of the underlying decoration.

The low-emissive property is used for example for ice-cube tray covers to keep in the cold and slow down the appearance of condensation on the outer face, or else in fireplace inserts mainly to reduce dirt build-up.

The palette of colors that can be achieved remains the same as for a substrate without a layer. This is particularly striking for all the light colors that would not be feasible on top of a layer that would give a brown to yellow appearance in transmission depending on its thickness and its nature.

In addition, for the product ranges that require an adaptation of the resistance of the layer according to the specifications, hence an adaptation of its thickness, it is pointless to adapt the color. For example, a radiator façade may be available in various powers. Usually, several resistances per square, hence several layer thicknesses are necessary to provide the range, so the invention makes it possible to prevent an adjustment of the color of the decoration necessary to remain uniform if, conversely, the decoration is placed directly on the layer.

The invention therefore makes it possible to design substrates that support both a decoration and a functional layer, broadening the product range that can be produced and also making it possible to obtain more compact structures.

The layer may be directly on the decoration or an intermediate layer may be inserted.

Furthermore, the heating layer itself may be covered for example with an electrically insulating layer, for example a plastic film.

In the present invention, “decorative element” means a network of geometric patterns of simple shape—round, square, rectangular, star-shaped, diamond-shaped—or of more complex shape, placed for example in staggered rows, and a continuous background—covering the whole surface or a portion of the surface—that is single-colored or multicolored or else a design.

This decorative element may also form an identification element (marker etc.) or a display such as a logo or a commercial name, or else a masking element (of an attachment or assembly element, etc.).

The decorative element may be colored, white, black, pastel-colored, translucent, semiopaque and/or opaque.

The decorative element is enamel-based, which makes it possible to manufacture a decorated structure quickly and easily even on an industrial scale.

If the substrate is made of glass to be toughened and/or if the layer is deposited at high temperature for example by pyrolysis, the enamel can support the temperatures required for heat-toughening (maximum temperature of the order of 650° C.) and for this type of deposition.

The enamel used for the invention may be any composition comprising a glass frit possibly associated with pigments (as colorants, these pigments being able to form part of the frit), and a medium.

The glass frit may be any glass frit making it possible finally to form a vitreous matrix on the support. Mainly for recycling considerations, a frit that contains substantially no lead is preferred.

The medium ensures that the solid particles are correctly suspended and allows the enamel to be applied and to temporarily adhere to the glass. The medium is usually chosen from organic elements such as pine oil, terpenes, mineral oils, diluents and resins.

Preferably, when the decorative element partially covers said face, the thickness of the decorative element may be less than or equal to 20 μm, preferably less than or equal to 10 μm.

In this manner, by limiting the thickness, the stair-step effect is limited.

More generally, when the layer is deposited on a decoration with distinct height reliefs, or on a relief and the bare substrate, care is taken that the height difference is preferably less than or equal to 20 μm preferably less than or equal to 10 μm.

The decorative element may be distributed uniformly over the whole surface or cover one or more zones depending on the aesthetics and/or the desired visibility requirements.

Several decorations may be juxtaposed or superposed. For example, a network of decorative patterns may be multiple and thus combine several forms of geometric patterns, for example in the form of interlaced networks.

Similarly, the width of the pattern may be variable (for example gradually reducing with decreasing width toward the center in order to clear a zone for maximum visibility).

The decorative element may comprise a light-colored decorative portion (white included) and preferably the difference in absolute value between the calorimetric index b* of the structure and the colorimetric index b* of a similar structure in which a functional layer is placed between a substrate and a decorative element may be greater than or equal to 1 preferably greater than or equal to 2.

Alternatively or in combination, the decorative element may comprise a dark-colored decorative portion (black included) and preferably the structure has a substantially uniform visual appearance in said decorative portion.

The decorative element may form a strip of constant or variable width, for example placed along one edge of the substrate, opposite edges or even surrounding the whole substrate, thereby forming a peripheral strip. The decorative element according to the invention may also form a ring.

Furthermore, the structure may comprise a network of patterns made of conductive enamel in contact with the layer, placed between the decorative element and/or the substrate and the layer.

These patterns in contact with the heating layer allow differentiated heating zones to be formed even when the heating layer entirely covers the surface.

Silver particles are preferred particularly because they have an advantageous conductivity/cost ratio. It is also possible to choose an enamel containing other metal particles that are more conductive than the layer, chosen from particles of nickel, zinc copper or precious metals such as gold, platinum or palladium.

These patterns may also form part of the decorative element or be hidden by the latter. This makes it possible to juxtapose or superpose where necessary functional elements of decoration with purely decorative elements.

Preferably, the thickness of these patterns may be less than or equal to 20 μm, preferably less than or equal to 10 μm.

For its electric supply the heating layer is connected to elements of electric connection to current-bearing cables these elements being called connection parts or current-bearing terminals or distributor strips or “busbars” or else distributors.

The chosen heating layer may advantageously be electrically supplied by conductive enamel-based distributors, the distributors preferably being silver-based, distributors placed between the substrate or the decoration and the layer.

Preferably the thickness of the distributors may be less than or equal to 20 μm, preferably less than or equal to 10 μm. Care should preferably be taken to obtain a maximum current density of the order of 100 A/mm².

In addition, it is possible preferably to choose for conductive patterns an enamel identical to that used for the distributors for manufacturing and producing patterns and distributors in a single pass.

The chosen heating layer is an electrically conductive layer having a given specific resistance R1 in order to obtain the given overall resistance that can be varied according to the applications (heating function, condensation prevention, etc.).

Note that the overall electric resistance R of a layered heating element is given by the following formula:

R=R1*D/L

where D corresponds to the dimension of the layer in the direction of the current and L is the dimension of the layer in the direction perpendicular to the current.

Preferably, the heating layer may have a specific resistance of between 10 and 100 ohms.

The layer may entirely cover the surface or be arranged in a plurality of heating zones, for example heating strips with their own electric supply for differentiated heating. The decoration may be covered by only one or by several strips.

Preferably, the low-emissive layer may have a specific resistance of between 8 and 50 ohms, preferably of between 10 and 20 ohms.

The layer may preferably be metal oxide-based, preferably fluorine-doped tin oxide, or else tin-doped indium oxide.

The fluorine-doped tin oxide layer may preferably be obtained by the pyrolysis method (by means of powder, liquid or else more preferably gaseous or CVD). “Pyrolyzed” layers are advantageous because of their adhesion their stability, their hardness, and therefore their mechanical and air strength.

It is also possible to choose other suitable layers from the “TCO” (for transparent conductive oxide) family. Furthermore, the layer may be a multilayer.

It is possible to envisage other methods of deposition, notably coating deposition of a paint, by “dip-coating”, by “spin-coating”, by “flow-coating”, by “PVD” spraying, etc.

The layer may preferably be a transparent layer. However, when the decorative element forms a continuous dark background and/or when a visibility zone is not required, it is of course possible to choose a heating layer having a certain opacity.

Furthermore, the substrate may be a substrate with one or the following characteristics:
transparency, for example with a light transmission of at least 60%, even 80% or even 90%,
heat-resistance.

The substrate may participate in the decoration, for example it may be colored, for example the product called “Parsol bronze” sold by SAINT GOBAIN, and may have translucent, frosted, opaque, etc. zones.

Preferably, the substrate may be of the glass type, particularly made of glass or glass-ceramic.

The glass may for example, be soda-lime-silica glass or boron-silica glass, in particular for applications requiring good heat resistance (heating, etc.).

The structure may be substantially flat or be of a more complex shape such as bent. The glass may be bent and/or toughened, and for example is between 3 and 10 mm thick.

The invention may apply to any shape of substrate (square, rectangular, round, oval, trapezoidal, semicircular, polygonal, etc.).

In a first preferred embodiment, the layer is chosen to be heating and the structure forms at least one of the following elements:
an indoor installation heating element,
an element of household electrical equipment,
an element of commercial or domestic refrigeration equipment,
an industrial equipment element for foodstuffs,
and a heating glazing unit for aviation or railways.

This may include in particular:
a glazed portion for a heating shelf, a heating façade for a towel drier or radiator, a plate warmer,
a glazed portion of a foodstuff or nonfoodstuff counter showcase,
an ice-cube tray cover, a cover for a refrigerated chest, a glazed portion for a refrigerated cupboard.

In a second preferred embodiment, the layer is chosen to be low-emissive and the structure forms at least one of the following elements:
an indoor installation element,
an element of household electrical equipment,
an element of commercial or domestic refrigeration equipment,
an element of industrial equipment for foodstuffs.

It is also possible to cite in particular a fireplace insert, a stove door, a glazed portion of a counter showcase, an ice-cube tray cover, a cover for a refrigerated chest, a glazed portion for a refrigerated cupboard.

In addition, on the other face, a substantially transparent or lightly colored coating may be incorporated having another functionality, for example antifouling or else antireflection.

To manufacture the decorated structure, it is not envisageable to produce an enamel decoration prior to depositing a layer on a flat glazing element with the current process of direct deposition on a float line (hot).

Furthermore, it is difficult to envisage applying the enamel decoration prior to the deposition of a layer on the magnetron line because this deposition is carried out directly on the bed (float line), that is to say on glass of large dimensions. This method would involve predicting the cutoff positions and modifying them on request which would therefore result in a complex method.

Also, an additional subject of the invention is a method for manufacturing the structure that is decorated and has a simple and reliable functional layer that can be produced on an industrial scale.

For this purpose the invention proposes a method for manufacturing a decorated structure as previously described comprising the following successive operations:
dimensioning of the substrate,
screenprinting of said enamel-based decorative element,
the deposition of said functional layer on said substrate by pyrolysis.

Such a method is simple to apply and has more flexibility.

Preferably, the method may comprise a screenprinting of the distributors.

Preferably for better output and/or simplicity of application, in one stoving process, the enamel stoving and deposition operations and preferably a bending and toughening or toughening operation are carried out.

In an advantageous embodiment, the pyrolysis is by gaseous means (CVD).

This confers better uniformity on the layer, which is necessary particularly when a visibility zone is required.

Other details and advantageous features of the invention appear on reading the examples of devices illustrated by the following figures:

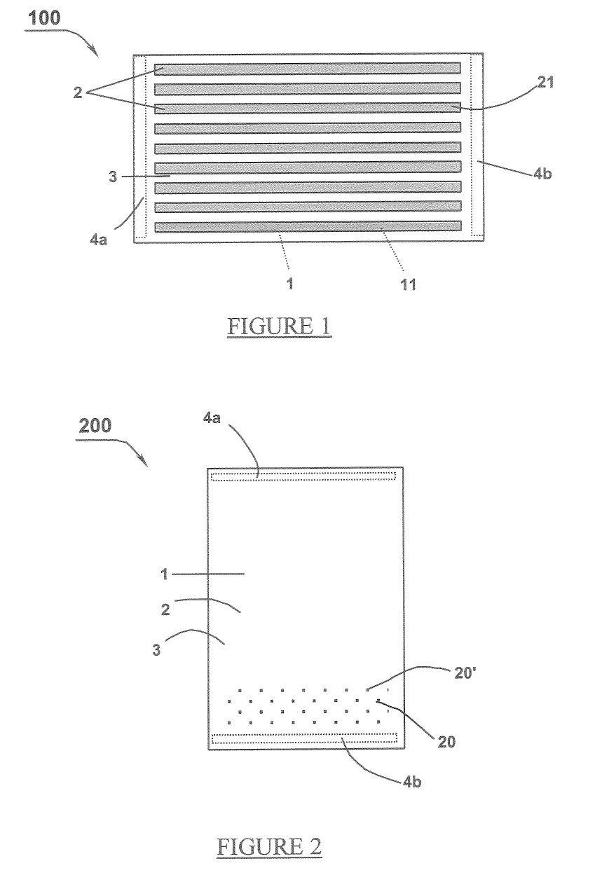

FIG. 1 represents schematically a front view of a decorated radiator façade in a first embodiment of the invention;

FIG. 2 represents schematically a front view of a façade of a decorated towel drier in a second embodiment of the invention;

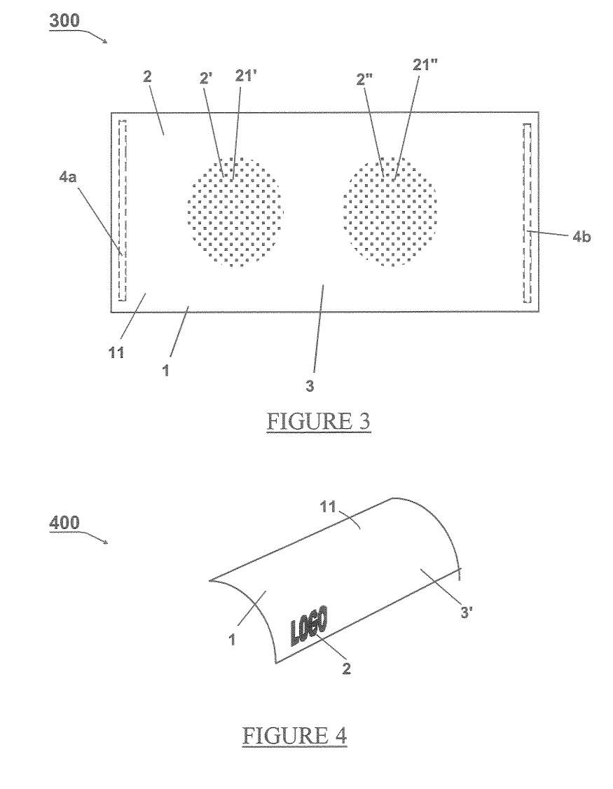

FIG. 3 represents schematically a front view of a decorated plate warmer in a third embodiment of the invention;

FIG. 4 represents schematically a view in perspective of a decorated ice-cube tray cover in a fourth embodiment of the invention;

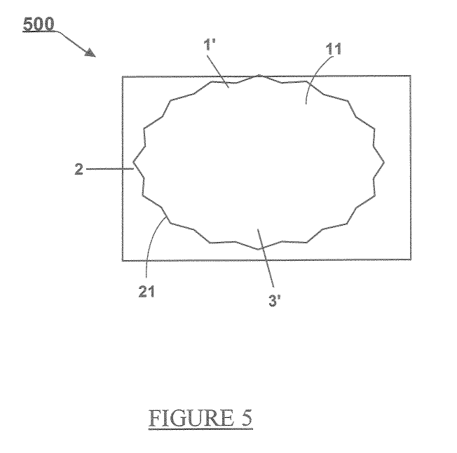

FIG. 5 represents schematically a front view of a decorated fireplace insert in a fifth embodiment of the invention.

First of all, it is specified that, for clarity purposes, not all the figures strictly comply with the proportions between the various elements represented and that the elements appearing transparently are represented in continuous lines and the hidden elements are in dotted lines.

### EXAMPLE NO 1

FIG. 1 represents schematically a front view (that is to say a front side view 11) of a decorated radiator façade 100 in a first embodiment of the invention.

The radiator façade 100 consists of a soda-lime-silica glass sheet 1 that is 4 mm thick and is provided on its rear face:
with a decoration 2 made of light blue enamel in the form of rectangular strips 21 parallel to the longitudinal edges of the glass sheet 1,
with a heating element consisting of a fluorine-doped tin oxide layer 3 deposited by CVD means covering this face on top of the decoration,
with two silver paste and screenprinted strips forming distributors 4a, 4b, deposited on the glass and optionally on the decoration along the lateral edges of the glass sheet 1, these distributors being connected to electric cables (not shown) and hidden by a surround (not shown).

The decoration 2 and the distributors 4a, 4b each have a thickness of 10 μm to prevent creating too great a “stair-step”.

The proportions necessary to produce the layer with the correct overall resistance are adjusted knowing that these proportions differ relative to direct deposition on glass. The layer behaves differently by reason of the greater roughness of the decorative enamel compared with that of the glass, so it is necessary to adjust the proportions to obtain the same resistance per square on an enamel and hence the correct overall resistance.

Therefore, the distance between the distributors being 700 mm and the length being 500 mm, the specific resistance of the layer is adapted to 93 ohms to obtain a theoretical heating temperature of 80° C. These input data are listed in table 1a below.

TABLE 1a

| Input data | Example N° 1 | |
|---|---|---|
| Target heating temperature | 80° | C. |
| Target overall resistance | 126 | ohms |
| Supply voltage | 230 | V |
| Dimensions | 700*500 | mm |

| | |
|---|---|
| Decoration color | Light blue |

The desired heating characteristics and the blue color are obtained. These output data are listed in table 1b below. For comparison if this layer was beneath the decoration, the appearance would be greenish due to the yellowing.

TABLE 1b

| Output data | Example N° 1 | |
|---|---|---|
| Specific resistance | 93 | ohms |
| Power obtained | 420 | W |

| | |
|---|---|
| Color in transmission | Light blue |
| (decoration zones) | |

To manufacture the radiator façade 100, the glass 1 is dimensioned, the decoration 2 and the distributors 4 are screenprinted, and, in an oven, the enamels are stoved, the layer 3 is deposited by CVD and a toughening is carried out.

### EXAMPLE NO 2

FIG. 2 represents schematically a front view of a decorated façade of a towel drier 200 in a second embodiment of the invention.

This façade of a towel drier 200 consists of a sheet of soda-lime-silica glass 1 that is 4 or 6 mm thick and is provided on its rear face:
with a decoration 2 in the form of a continuous white background covering the surface,
with a heating element consisting of a fluorine-doped tin oxide layer 3 covering this face on top of the decoration,
with two silver paste and screenprinted strips forming distributors 4a, 4b, deposited on the decoration 2 and beneath the layer 3 along the lateral edges of the glass sheet 1, these distributors being connected to electric cables (not shown) and hidden by a surround (not shown).

After installation, this façade of a towel drier 200 is for example vertical. This heating façade may be supplemented by a bar adjusted to the desired height in order to hold a towel. This façade may also be used without modification as a radiator heating façade.

In addition, in order to obtain differentiated heating zones, a network 20 of silver-based enamel studs 20′ is placed in the bottom portion between the decoration 2 and the layer 3. The studs 20′ are placed in staggered rows to prevent hot spots. Their diameter is of the order of one millimeter. With such a network, the current is not diverted and the heating remains substantially uniform in each zone.

The silver studs 20′ and the distributors 4a, 4b are each preferably 10 μm thick.

The network 20 is placed in the bottom portion of the towel drier 200 to increase the heating temperature in this zone which makes it possible to substantially compensate for the temperature difference.

All things being equal, in the absence of this network, the temperature difference associated with the natural convection effect would be of the order of 15° C. (80° C. for the top portion, 65° C. for the bottom portion).

The coverage rate—corresponding to the total surface area of all the patterns on the total surface occupied by the network of patterns—is therefore adjusted according to the desired equivalent specific resistance.

The width of the bottom zone containing the network 20 is 0.28 mm and its specific resistance is adapted to 42 ohms instead of 51 ohms for a layer that would give a heating temperature of 80° C. without taking account of natural convection.

The width of the top zone is 0.70 mm and its specific resistance is adapted to 60 ohms.

Also, based on input data that are the supply voltage of 230 V, the glass dimensions of 1000×400 mm and a desired uniform temperature equal to approximately 70° C. over the whole surface area, thanks to the invention, the façade of the corresponding towel drier 200 has been produced with a real temperature over the whole surface area of 70° C., by adapting (reducing) the equivalent specific resistance by the addition of conductive patterns judiciously positioned in the bottom zone and by adjusting the specific resistance of the unmodified top zone. The main input data are listed in table 2a below.

The performance is obtained by retaining great freedom in the choice of the aesthetics. In a variant, these patterns 20′ may be visible and therefore form part of the decoration.

TABLE 2a

| Input data | Example N° 2 | |
|---|---|---|
| Real temperature on | 70° | C. |
| the surface | | |
| Supply voltage | 230 | V |

| | |
|---|---|
| Dimensions | 1000 × 400 mm |
| Decoration color | white |

TABLE 2b

| Output data | Example N° 2 | |
|---|---|---|
| Theoretical heating | 65° | C. |
| temperature (top zone) | | |
| Specific resistance (top | 60 | ohms |
| zone) | | |
| Theoretical heating | 80° | C. |
| (bottom zone) | | |
| Specific resistance | 42 | ohms |
| (bottom zone) | | |

| | |
|---|---|
| Color in transmission | white |
| (decoration zones) | |

The desired heating characteristics and the white background are obtained. These output data are listed in table 2b. For comparison, if this layer were beneath the decoration, the appearance would be yellowish.

To manufacture this façade 200, the glass 1 is dimensioned, the decoration 2 is screenprinted, then the distributors 4a, 4b and the network 20 are screenprinted, and, in an oven, the enamels are stoved, the layer 3 is deposited by CVD and a toughening is carried out.

### EXAMPLE NO 3

FIG. 3 represents schematically a Front view of a decorated plate warmer 300 in a third embodiment of the invention.

The plate warmer 300 consists of a rectangular sheet of glass 1 on which is deposited on its rear face:
a decoration 2 in the form of a continuous gray enamel-based background that however leaves round uncovered portions that will form centered heating rings to keep cooked meals or foodstuffs warm,
two silver paste and screenprinted strips forming distributors 4a, 4b placed along the lateral edges of the glass sheet 1 and connected to electric cables (not shown) and hidden by a surround (not shown),
two networks 2′, 2″ of silver-based enamel studs 21′, 21″, for example identical, these networks being placed in the heating rings,
a heating element consisting of a fluorine-doped tin oxide layer 3 deposited on this face on top of the decoration, the networks and the distributors.

The decoration 2, the silver studs 21′, 21″ and the distributors 4a, 4b each have a thickness of 10 μm.

In the zone of the heating rings, the equivalent specific resistance falls to 31 ohms with a coverage rate of 51%.

In the nonfunctional zone, the specific resistance of the layer 3 is chosen to be equal to 62 ohms.

Also, based on input data that are the supply voltage of 230 V, a ring diameter of 200 mm, a distance between distributors of 800 mm, the desired temperatures equal to 80° C. in the nonfunctional zone and 120° C. in the functional zones, the corresponding plate warmer 400 has been produced without sacrificing the aesthetics, by adapting (reducing) the equivalent specific resistance by the addition of appropriate conductive patterns in functional zones and by choosing the specific resistance of the nonfunctional, patternless zone. The main input data are listed in table 3a below.

In a variant, these patterns 21′, 21″ may be invisible for example by producing identical gray patterns during the formation of the gray background.

TABLE 3a

| Input data | Example 3 | |
|---|---|---|
| Target temperature | 120° | C. |
| (heating ring zones) | | |
| Target temperature | 80° | C. |
| (outside the heating | | |
| ring zones) | | |
| Supply voltage | 230 | V |

| | |
|---|---|
| Dimensions | 200 mm × 800 mm |
| Main decoration color | gray |

TABLE 3b

| Output data | Example 3 |
|---|---|
| Specific resistance | 31 ohms |
| (heating ring zones) | |
| Specific resistance | 62 ohms |
| (outside the heating | |
| ring zones) | |
| Background color in | gray |
| transmission | |

The desired heating characteristics and the required aesthetics, namely a dark background of substantially uniform visual appearance and visible heating rings see table 3b) are obtained. For comparison, if this layer were beneath the decoration the defects of the layer would be revealed.

To manufacture this façade 300 the glass 1 is dimensioned the decoration 2 is screenprinted, then the distributors 4a, 4b and the networks 2′, 2″ are screenprinted, and, in an oven, the enamels are stoved, the layer 3 is deposited by CVD and a toughening is carried out.

It is also possible to conceive of a heating shelf with temperatures that can vary according to the type of foodstuff to be kept warm or else according to the desired heating geometry.

### EXAMPLE NO 4

FIG. 4 represents schematically a view in perspective (front face side 11) of a decorated ice-cube tray cover in a fourth embodiment of the invention.

This cover 400 consists of a sheet of soda-lime-silica glass 1 that is 4 mm thick and is provided on its rear face:
with a white enamel decoration 2 in the form of a logo—or, in a variant, an indication display or a commercial name,
with a low-emissive layer 3′ that is preferably made of fluorine-doped tin oxide deposited on top of the decoration and covering the totality of this face.

The specific resistance of the layer 3′ is preferably chosen to be equal to 10 ohms.

TABLE 4

| | | Decoration |
|---|---|---|
| | Decoration | on the layer |
| | on the layer | Comparative |
| Output data | Example N° 4 | example |
| Color in | white | yellow |
| transmission | | |
| L* | 73.26 | 64.08 |
| a* | −2.43 | −2.46 |
| b* | 1.04 | 4.35 |

| | |
|---|---|
| DE* | 9.75 |

The data on the aesthetics defined based on the color space L* (lightness) and on the indices a*, b* and DE* are presented for example 4 and for a comparative example for which the decoration is beneath the layer in table 4 above.

If this layer is beneath the decoration, the appearance of the logo is yellowish. The difference in absolute value between the colorimetric index b* of the structure of example 4 and the calorimetric index b* of the comparative example is equal to 3.31. Facing the logo, condensation is also observed.

The desired cold retention and delayed condensation characteristics and the required aesthetics namely white, are obtained.

To manufacture this cover 400, the glass 1 is dimensioned, the decoration 2 is screenprinted, then, in an oven, the enamel 2 is stoved, the layer 3′ is deposited by CVD and a bending and toughening are carried out.

As a variant, it is possible to add a screenprinting of distributors and where necessary of the conductive networks in the bottom portion in order to obtain an electric heating cover that is yet more effective against condensation for hot and humid environments.

### EXAMPLE NO 5

FIG. 5 represents schematically a front view (front face side 11) of a decorated fireplace insert 500 in a fifth embodiment of the invention.

This insert 500 consists of a glass-ceramic plate 1′ that is 4 mm thick and is provided on its rear face:
with a decoration 2 in the form of a brown enamel peripheral strip 21,
with a low-emissive layer 3′ that is preferably of fluorine-doped tin oxide deposited on top of the decoration 2 and covering the totality of this face.

The specific resistance of the layer 3′ is chosen to be equal to 10 ohms.

A sufficiently high surface temperature on the rear face is obtained to very greatly reduce soot (antifouling effect) and also the required aesthetics, namely a dark-colored strip with a substantially uniform visual appearance. For comparison, if this layer were beneath the decoration, the defects of the layer would be revealed and also the soot would remain attached to this strip.

To manufacture this insert 500, the glass-ceramic 1′ is dimensioned, the decoration 2 is screenprinted, then, in an oven, the enamel 2 is stoved, and the layer 3′ is deposited by CVD.

1. A decorated structure (100 to 500) comprising:
an at least partially transparent substrate (1, 1′),
an enamel-based decorative element (2, 2′, 2″) on one face of the substrate,
a functional layer (3, 3′) that is chosen from an electrically supplied heating layer or a low-emissive layer, the layer being deposited on said face and at least partially covering said decorative element.

2. The decorated structure (100 to 500) as claimed in claim 1, characterized in that, when the decorative element (2 to 2″) partially covers said face, the thickness of the decorative element is less than or equal to 20 μm, preferably less than or equal to 10 μm.

3. The decorated structure (100 to 400) as claimed in one of claims 1 or 2, characterized in that the decorative element comprises a light-colored decorative portion (2, 2′, 2″) and preferably the difference in absolute value between the calorimetric index b* of the structure and the calorimetric index b* of a similar structure in which a functional layer is placed between a substrate and a decorative element is greater than or equal to 1, preferably greater than or equal to 2.

4. The decorated structure (300, 500) as claimed in one of claims 1 to 3, characterized in that the decorative element (2, 2′) comprises a dark-colored decorative portion and preferably the structure has a substantially uniform visual appearance in said decorative portion.

5. The decorated structure (500) as claimed in one of claims 1 to 4, characterized in that the decorative element comprises a peripheral strip (2′).

6. The decorated structure (200) as claimed in one of claims 1 to 4, characterized in that the decorative element (2) substantially covers said face.

7. The decorated structure (200, 300) as claimed in one of claims 1 to 6, characterized in that the structure comprises a network of patterns (20, 2′, 2″) made of conductive enamel in contact with the layer (3).

8. The decorated structure (100 to 300) as claimed in one of claims 1 to 7, characterized in that the chosen heating layer (3) is electrically supplied by conductive enamel-based distributors that are preferably silver-based.

9. The decorated structure (100 to 300) as claimed in one of claims 1 to 8, characterized in that the chosen heating layer (3) has a specific resistance of between 10 and 100 ohms.

10. The decorated structure (400, 500) as claimed in one of claims 1 to 8, characterized in that the chosen low-emissive layer (31) has a specific resistance of between 8 and 50 ohms, preferably of between 10 and 20 ohms.

11. The decorated structure (100 to 500) as claimed in one of claims 1 to 10, characterized in that the layer (3, 3′) is transparent.

12. The decorated structure (100 to 500) as claimed in one of claims 1 to 11, characterized in that the layer (3, 3′) is metal oxide-based, preferably made of fluorine-doped tin oxide.

13. The decorated structure (100 to 500) as claimed in one of claims 1 to 12, characterized in that the substrate (1, 1′) is a glass or a glass-ceramic.

14. The decorated structure (100 to 500) as claimed in one of claims 1 to 13, characterized in that the substrate is bent and/or toughened.

15. The decorated structure (100 to 300) as claimed in one of claims 1 to 14, characterized in that the layer (3) is chosen to be heating and the structure forms at least one of the following elements: a glazed portion for a heating shelf, a heating façade for a towel drier or radiator, a plate warmer, an ice-cube tray cover, a glazed portion of a foodstuff or nonfoodstuff counter showcase, a cover for a refrigerated chest, a glazed portion for a refrigerated cupboard, a glazed portion of a commercial or domestic refrigeration element, a heating element of an indoor installation or household electrical equipment, an industrial equipment element for foodstuffs, a heating glazing unit for aviation or railways.

16. The decorated structure (400, 500) as claimed in one of claims 1 to 14, characterized in that the layer (3′) is chosen to be low-emissive and the structure forms at least one of the following elements: a fireplace insert, an ice-cube tray cover, a glazed portion of a counter showcase, a cover for a refrigerated chest, a glazed portion for a refrigerated cupboard, a stove door, an element of an indoor installation or household electrical equipment.

17. A method for manufacturing a decorated structure (100 to 500) as claimed in one of claims 1 to 16, characterized in that it comprises the following successive operations:
dimensioning of the substrate (1, 1′),
screenprinting of said enamel-based decorative element (2 to 2″),
the deposition of said functional layer (3, 3″) on said substrate by pyrolysis.

18. The method for manufacturing a decorated structure as claimed in claim 17, characterized in that, in one stoving process, the enamel stoving and deposition operations and preferably a bending-toughening or toughening operation are carried out.

19. The method for manufacturing a decorated structure as claimed in one of claims 17 or 18, characterized in that the pyrolysis is by gaseous means.

20. The method for manufacturing a decorated structure as claimed in claims 17 to 19, characterized in that it comprises a screenprinting of the distributors.
